(19) United States
(12) Patent Application Publication
(10) Pub. No.: US 2008/0289582 A1
(43) Pub. Date: Nov. 27, 2008

(54) AQUARIUM NET ASSEMBLY

(75) Inventors: Ryan Rutherford, Belleville, NJ (US); Jonathan Willinger, Tenafly, NJ (US)

Correspondence Address: KATTEN MUCHIN ROSENMAN LLP, 575 MADISON AVENUE, NEW YORK, NY, 10022-2585, US

(73) Assignee: JW Pet Company Inc., Teterboro, NJ (US)

(21) Appl. No.: 11/752,549

(22) Filed: May 23, 2007

(51) Int. Cl. A01K 75/00

(52) U.S. Cl. 119/245

(57) ABSTRACT

The present invention is directed to an aquarium net assembly for an aquarium. The aquarium net assembly includes a net sack for retaining fish, a frame for holding the net sack, an ergonomic handle for holding the aquarium net assembly; and a wand connecting the frame to the handle. The present invention is also directed at a novel ergonomic handle for an aquarium net assembly for an aquarium. The handle includes an elongated body for holding the handle, the body having a proximal end and a distal end with respect to a net; and a cavity disposed in the proximal end for receiving a wand of the aquarium net assembly.

### FIELD OF THE INVENTION

The present invention relates to an aquarium net assembly. More particularly, the present invention relates to an aquarium net assembly having an ergonomic handle for comfortable manipulation of the aquarium net assembly and a structure for convenient and efficient storage during non-use.

### BACKGROUND OF THE INVENTION

Aquarium net assemblies are used in the aquarium hobby for removing and transporting fish from and to an aquarium tank, as desired. Such assemblies are immersed in water when in use and, thus, are inconvenient to carry from place to place for storage. Therefore, they are usually stored adjacent to the aquarium tank to be readily available for use when desired.

Customarily, the aquarium net assembly is placed on top of the tank as when a tank cover is provided. In such circumstances, the net is exposed to view and in many respects tends to detract from the aesthetic appearance of the aquarium. Similar problems are presented when a net is stored on shelves or the like adjacent to the aquarium stand.

U.S. Pat. No. 4,392,570 to A. H. Willinger, which is herein incorporated by reference for all purposes, teaches an aquarium net assembly that is now well known in the art. The assembly comprises a wand made of twisted wire terminating in a wide handgrip formed by looping the twisted wire. Typically, the looped wire of the handgrip is sleeved with a plastic tube.

The assembly known in art suffers from several drawbacks. The wide handgrip does not allow a comfortable grip and, in turn, does not permit easy manipulation of the aquarium net assembly. The typical user is forced to place one side of the handgrip in the valley formed between the proximal and intermediate phalanges, i.e. at the proximal interphalangeal joints, of the little, ring, and middle finger. The other side of the handgrip is placed in the palm at the base of the thumb muscle. The thumb and forefinger then pinch the wand. However, this position is highly uncomfortable and not ergonomic.

To permit cost-effective flat shipping and storage of the aquarium net assembly, the loop of the handgrip is in the same plane as the frame for the net. This structure of the aquarium net assembly forces a user to hold the aquarium net assembly at inconvenient angles. When the user's arm is extended, the net is rotated approximately 5-30 degrees left or right at the wrist from a vertical plane passing through the user's forearm and 15-45 degrees to the horizontal from the same vertical plane because of the grip in the user's hand. In other words, the relative position of handgrip to the frame results in the net sack being open to the top by 15-45 degrees from vertical and pivoted to the right or left by 5-30 degrees for an average user.

While this position makes a left to right or right to left scooping motion possible, it requires an uncomfortable twisting of the lower arm to bring the frame to a horizontal position so that the captured fish is not accidentally released. Indeed, an even more uncomfortable position exists when the frame is turned so that the opening faces downward to release the captured fish. Thus, a need exists for aquarium net assembly that is ergonomic and a handle for an aquarium net assembly that is ergonomic.

The '570 patent also propose a solution for storing the aquarium net assembly by providing a bracket having an inline C-shaped clip. However, this presents a further drawback.

The '570 patent teaches that the C shaped clip that has the opening in line with a longitudinal axis of the support arm of the bracket. When the wand of the aquarium net assembly is inserted in the opening, the arm must be held still. However, repeated mounting places undue stress on the arm leading to fracturing of the arm. Thus, a need exists for a bracket that is more durable.

What are desired are an aquarium net assembly, handle, and bracket that overcome the drawbacks known in the art.

### SUMMARY OF THE INVENTION

These and other needs and objectives are met by the present invention. Therein, the present invention is directed to an aquarium net assembly for an aquarium. The aquarium net assembly comprises a net sack for retaining fish, a frame for holding the net sack, an ergonomic handle for holding the aquarium net assembly, and a wand connecting the frame to the handle.

The present invention is also directed to a novel ergonomic handle for an aquarium net assembly for an aquarium. The handle comprises an elongated body for holding the handle, the body having a proximal end and a distal end with respect to a net, and a cavity disposed in the proximal end for receiving a wand of the aquarium net assembly.

The present invention is furthermore directed to a bracket for storing an aquarium net assembly during non-use. The bracket comprises a retainer for restraining movement of the bracket relative to another object, a clip for receiving a portion of the aquarium net assembly, and an arm connecting the retainer and clip.

### BRIEF DESCRIPTION OF THE INVENTION

The above features and other advantages will become more apparent from a detailed description taken in conjunction with the following drawings, in which:

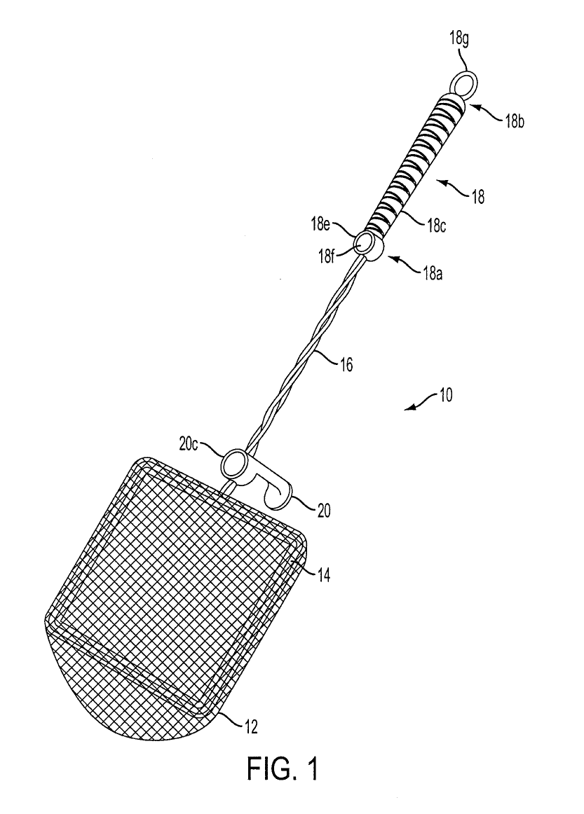

FIG. 1 is a perspective view of an aquarium net assembly including an ergonomic handle and a bracket in accordance with one embodiment of the present invention.

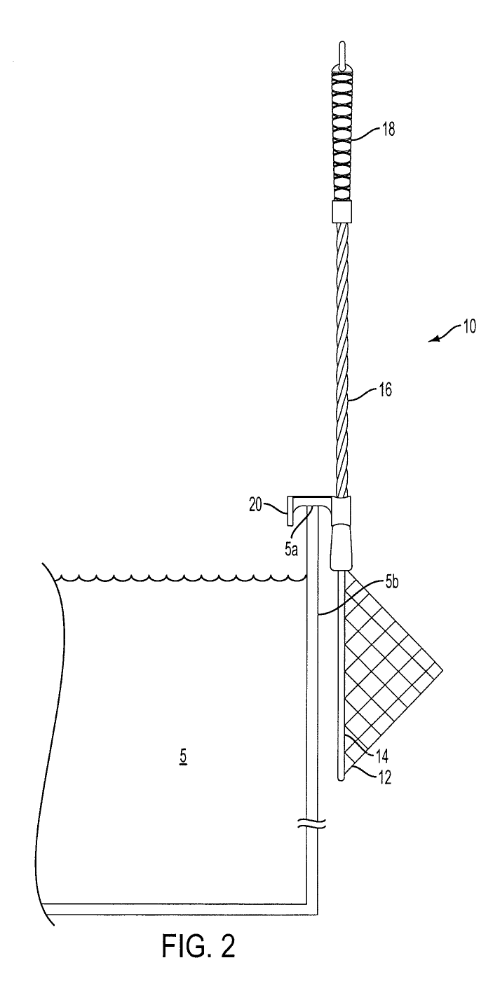

FIG. 2 is a side view of the aquarium net assembly of FIG. 1 including the ergonomic handle and the bracket while stored during non-use.

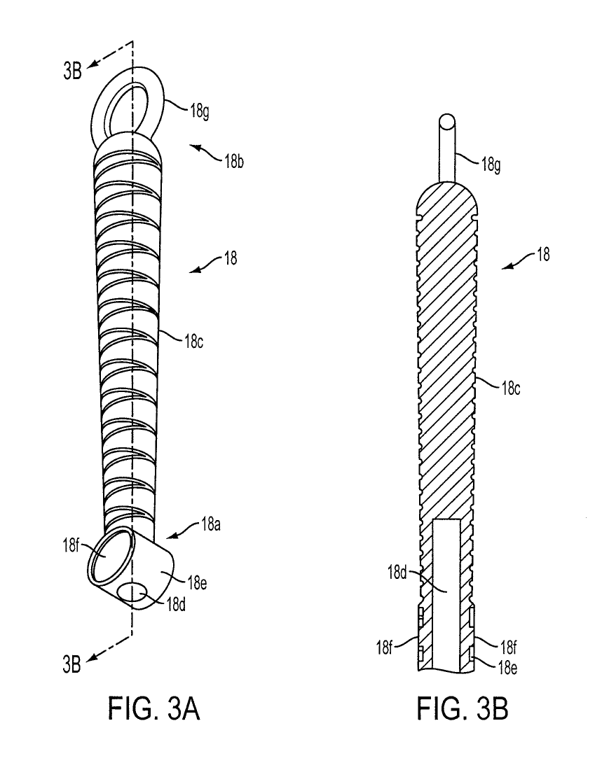

FIG. 3a is a perspective view of an ergonomic handle in accordance with one embodiment of the present invention.

FIG. 3b is a cross-sectional view of the ergonomic handle of FIG. 3a.

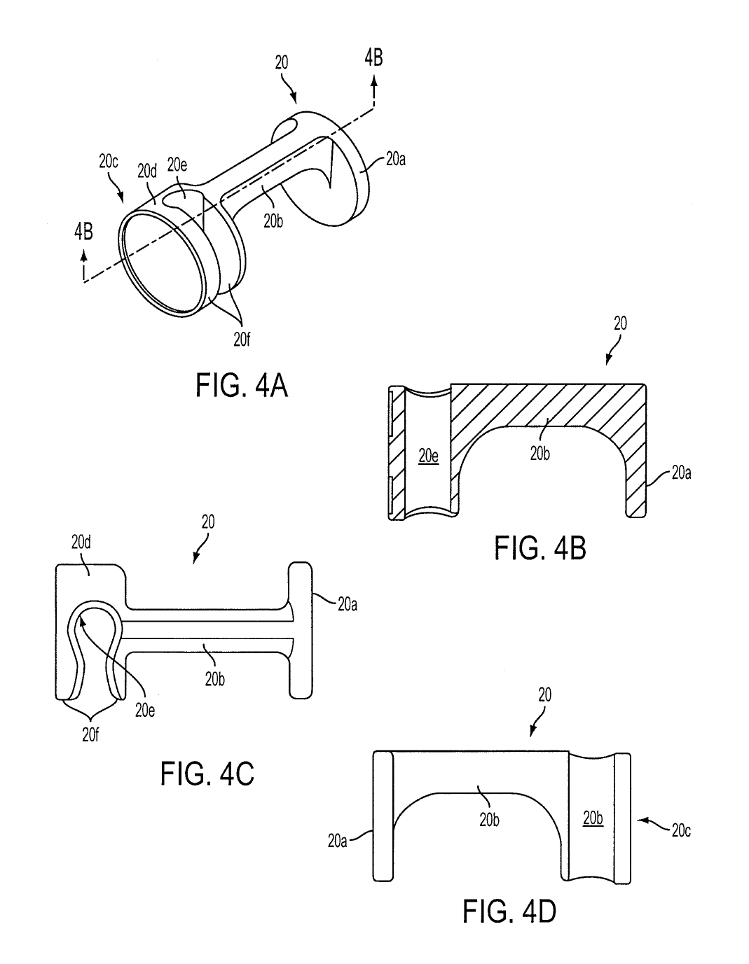

FIG. 4a is a perspective view of a bracket in accordance with one embodiment of the present invention.

FIG. 4b is a cross-sectional view of the bracket of FIG. 4a.

FIG. 4c is a top view of the bracket of FIG. 4a.

FIG. 4d is a rear view of the bracket of FIG. 4a.

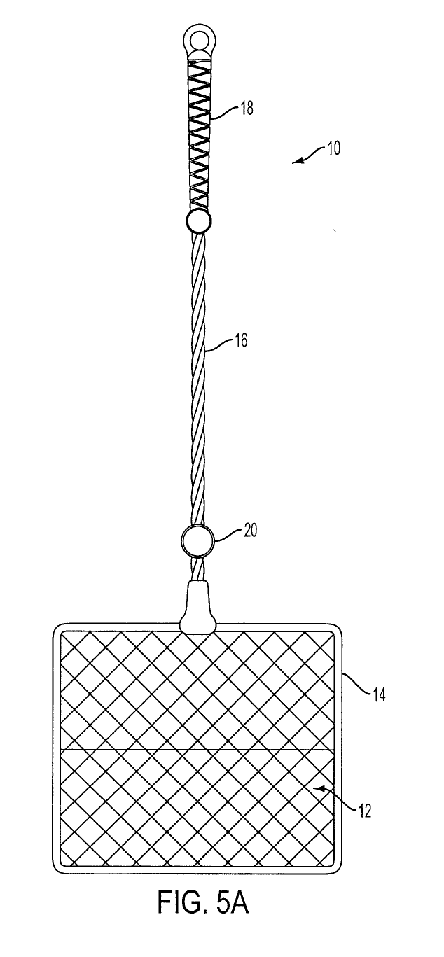

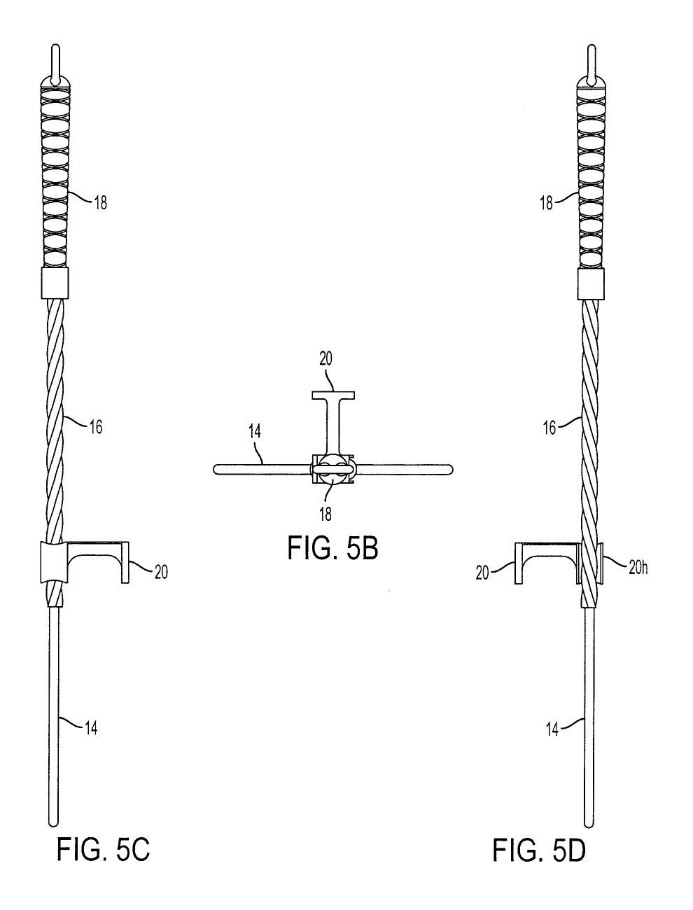

FIG. 5a is a top view of the aquarium net assembly, including the ergonomic handle and the bracket, of FIG. 1.

FIG. 5b is a front view of the aquarium net assembly, including the ergonomic handle and the bracket, of FIG. 1.

FIG. 5c is a left side view of the aquarium net assembly, including the ergonomic handle and the bracket, of FIG. 1.

FIG. 5d is a right side view of the aquarium net assembly, including the ergonomic handle and the bracket, of FIG. 1.

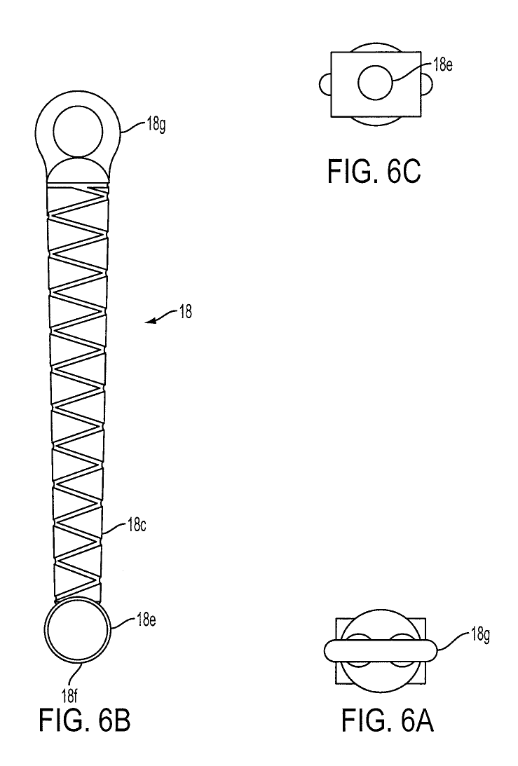

FIG. 6a is a top view of the handle of FIG. 3a.

FIG. 6b is a front view of the handle of FIG. 3a.

FIG. 6c is a bottom view of the handle of FIG. 3a.

### DETAILED DESCRIPTION OF THE INVENTION

With respect to FIGS. 1-6, in accordance with one or more embodiments of the present invention, an aquarium net assembly 10 is used to remove and/or transport fish from an aquarium 5. It should be understood that the present application is not limited solely to aquarium, but also may be used in terrariums or the like, where fish or other small animals, such as salamander are habitated.

The aquarium net assembly includes an open mouth net sack 12 made of any suitable source material, such as nylon, which in turn is made into a netting material suitable to catch and retain fish. The net sack may be connected to a frame 14 by a variety of means, including sewing the frame into a peripheral edge of the net sack, by gluing a peripheral edge of the net sack to or over the frame, molding a peripheral edge of the net sack into the frame, overmolding a peripheral edge of the net sack to the frame, or any other suitable means.

A wand 16 connects the frame to a handle 18. The frame and/or the wand may be made of wire having a suitable gauge and may be twisted to form a structure. Each wire or all wires are preferably coated with suitable spray or solid coating, such as plastic or an elastomeric, for example, polyvinyl chloride, to prevent corrosion and/or damage. However, any suitable molded or extruded plastic or non-plastic material may also be used to form the frame and/or wand.

The frame and wand are preferable suitably sized to catch fish and/or other small creatures typically habitated in an aquarium, terrarium or the like. In fact, the frame, wand and/or the aquarium net assembly may be made in different sizes to accommodate differently sized aquariums 5.

Handle 18 comprises an elongated body 18c having a proximal end 18a and a distal end 18b. Proximal end 18a is disposed closer than the distal end to the frame and preferably includes a cavity 18d for receiving an end portion of the wand to secure the wand to the handle.

Preferably, body 18c is tapered longitudinally from the proximal end to the distal end or if a hilt is used from a portion adjacent to the hilt to the distal end.

Preferably, the body is configured to have a small circular cross-sectional shape of, for example, a diameter of approximately 10 mm at the proximal end and approximately 12.5 mm at the distal end. The body is preferably at least 100 mm long. Although, as explained below a circular cross-sectional shape especially with a tapered body provides significant advantages, any other suitable cross-sectional shape and dimensions may be used and provide some advantages over the art.

Preferably, cavity 18d is arranged to be substantially longitudinal and may share a common longitudinal axis with the wand and/or the handle. To aid in retaining the wand in the handle, the two may be glued together, the handle may be overmolded onto the wand, or the wand may be press-fit into the handle. The two may also be joined by any other suitable means.

In accordance with one embodiment of the present invention, handle 18 may include a hilt 18e which may be provided at the proximal end of the body to prevent the hand of a user from slipping forward of the handle. When a hilt is provided, cavity 18d passes through the hilt along preferably the same axis as the cavity does in the rest of the handle.

The hilt may be suitably provided with a space 18f for having a suitable logo or design.

In accordance with one embodiment of the present invention, a loop 18g is provided at distal end 18b to permit the aquarium net assembly to be hung from a support, such as a hook by the user or to be hung from a product display by a retailer.

The loop may be configured as full or partial circle, or may have any other shape. Preferably, loop 18g may be disposed integrally with the handle and be made of the same material.

In accordance with another embodiment of the present invention, the loop may be formed separately from the handle. For example, the loop may be formed from twisted wire and have a longitudinal end portion that is received at the distal end of handle in a cavity. Therein, the end portion may be joined to the handle as described with respect to the wand being joined to the handle.

In accordance with a further embodiment of the present invention, the loop may be formed integrally with the wand. Therein, the handle may comprise a longitudinal cavity that extends from the proximal to the distal end and the wand is extended so that it passes through the cavity. In assembly, the wire of the wand is passed through the cavity and a loop is formed by arranging the wire in a suitable shape. Therein, the portion of the wand extending through the handle may or may not be joined to the handle as described with respect to the wand being joined to the handle.

In accordance with one embodiment of the present invention, the loop may be formed integrally with the wand. The handle may then be overmolded to a portion of the wand in proximity to the loop.

Advantageously, handle 18 provides a more ergonomic experience for the user. In contrast to the flat wide-looped handgrip of the prior art, the relatively small circular cross-sectional handle permits a user to hold the handle ergonomically.

The general arrangement of length of the handle body, permits the typical user to place the handle in the valley formed between the proximal and intermediate phalanges of the little, ring, middle, and index finger, i.e. all proximal interphalangeal joints of the hand and not just at the little, ring, and middle finger as in the prior art. In fact, the user is able to curl his fingers around the handle body which is not possible with the handgrip known in the art.

Thus, the user may conveniently hold the net open at any suitable angle relative to a vertical plane passing through the user's forearm. Once a fish has been caught, for example, by a swooping motion, the user is able to orient the net to prevent inadvertent release of the captured fish, by rolling the handle between thumb and index finger or thumb and all fingers. Thus, unlike the prior art the user's wrist is not stressed. After transporting the fish, the user can release the fish by repeating the rolling motion of the handle in the opposite direction.

The rolling motion is aided by the longitudinal taper of the handle body. To further aid in the ergonomic design of the handle, a textured surface 18h is provided on the handle. Preferably, the surface is textured to permit water to flow from the handle and/or to especially usable in a rolling action.

The aquarium net assembly preferably includes a bracket 20 for mounting the aquarium net assembly to an edge 5a of a wall 5b of the aquarium. The bracket may be made from any suitable material and have any suitable dimensions, but preferably is made from durable plastic that is injection molded.

Bracket 20 includes retainer 20a for retaining the bracket, i.e. the aquarium net assembly, relative to the wall. The retainer may be in the form of a disk or other shape that provides a suitable surface area to bear against another object such as a wall.

An arm 20b connects the retainer to a clip 20c. The arm is preferably integral with the retainer and sized suitably small. The reduced size and preferably its connection point at an upper peripheral edge of the retainer permit the retainer to have a large bearing area to bear against the wall of the aquarium.

Clip 20c comprises a body 20d having a cavity 20e that is sized to receive a portion of wand 16 to mount the bracket to the aquarium net assembly. A pair of lips 20f forms a passage 20g for passing the wand into the cavity Preferably, the lips are directed towards each other to form a reduced area. In doing so, the lips help to clamp the wand into the cavity.

At the other end of the arm, the arm is connect to the central body so that a void space exists between the central body, i.e. clip, and the retainer to receive the wall of the aquarium.

On a peripheral surface of the central body that is approximately opposite the passage is a pressing surface 20h. In use, the longitudinal axis of the cavity is perpendicular to the axis of the arm. A user may thus press the bracket onto the wand by using the pressing surface on the central body of the clip.

While the invention has been described in conjunction with specific embodiments, it is to be understood that many alternatives, modifications, and variations will be apparent to those skilled in the art in light of the foregoing description.

What is claimed is:

1. An ergonomic handle for an aquarium net assembly for an aquarium, the handle comprising:
an elongated body for holding the handle, the body having a proximal end and a distal end with respect to a net; and
a cavity disposed in the proximal end for receiving a wand of the aquarium net assembly.

2. The ergonomic handle of claim 1, wherein the body is textured for easier holding of the body.

3. The ergonomic handle of claim 2, wherein the body is ribbed for easier holding of the body.

4. The ergonomic handle of claim 1, further comprising a hilt at an end of the body, the hilt for preventing a hand from slipping of the handle.

5. The ergonomic handle of claim 1, wherein the body is tapered.

6. The ergonomic handle of claim 4, wherein the body is tapered from narrow to wider from the proximal end to the distal end.

7. The ergonomic handle of claim 1, further comprising a loop at the distal end.

8. The ergonomic handle of claim 7, wherein the loop is closed.

9. The ergonomic handle of claim 1, wherein the body has a length suitable for holding in one hand.

10. The ergonomic handle of claim 1, wherein the body has a cross-sectional shape for convenient rotation of the handle in one hand.

11. The ergonomic handle of claim 9, wherein the body has a cross-sectional shape for convenient rotation of the handle in one hand.

12. An aquarium net assembly for an aquarium, the aquarium net assembly comprising:
a net sack for retaining fish;
a frame for holding the net sack;
an ergonomic handle for holding the aquarium net assembly;
a wand connecting the frame to the handle.

13. The aquarium net assembly of claim 12, further comprising a bracket for storing the aquarium net assembly on an edge of the aquarium.

14. The aquarium net assembly of claim 12, wherein the handle comprises an elongated body having a cross-sectional shape for convenient rotation of the handle in one hand.

15. The aquarium net assembly of claim 14, wherein the body is textured for easier holding of the body.

16. The aquarium net assembly of claim 14, further comprising a hilt at an end of the body, the hilt for preventing a hand from slipping of the handle.

17. The aquarium net assembly of claim 14, wherein the body is tapered.

18. The aquarium net assembly of claim 17, wherein the body is tapered from narrow to wider from a proximal end to a distal end of the body.

19. The aquarium net assembly of claim 12, further comprising a loop integral to the handle.

20. A bracket for storing an aquarium net assembly during non-use, the bracket comprising:
a retainer for restraining movement of the bracket relative to another object;
a clip for receiving a portion of the aquarium net assembly;
an arm connecting the retainer and the clip.

21. The bracket of claim 20, wherein the clip comprises a cavity for receiving the portion of the aquarium net assembly and a pair of lips that narrow the cavity to retain the portion of the aquarium net assembly; the lips being oriented such that the portion of the aquarium net assembly is inserted in a direction perpendicular to the longitudinal axis of the arm.

22. The bracket of claim 20, wherein a surface of the bracket is textured.
